(19) United States
(12) Patent Application Publication
(10) Pub. No.: US 2024/0401631 A1
(43) Pub. Date: Dec. 5, 2024

(54) PROTECTIVE CAP AND FASTENING SCREW HAVING PROTECTIVE CAP MOUNTED THEREON

(71) Applicant: AKTIEBOLAGET SKF, GOTEBORG (SE)

(72) Inventors: Juergen WEIGLEIN, Oerlenbach (DE); Marcel Alfred MEMMEL, Ebenhausen (DE)

(21) Appl. No.: 18/675,272

(22) Filed: May 28, 2024

(30) Foreign Application Priority Data
Jun. 5, 2023 (DE) 102023205215.6

(51) Int. Cl. F16B 37/14; F16B 43/00

(52) U.S. Cl. CPC F16B 37/14; F16B 43/001

(57) ABSTRACT

An assembly includes a fastening screw having an end surface and a substantially cylindrical side surface extending axially away from the end surface and a protective cap covering the free end. The cap has a first end opening from which the fastening screw extends, a second end overlying the end surface of the fastening screw, a side wall surrounding a portion of the cylindrical side surface, an inner surface defining a cap interior, and an outer surface. A cap screw extends through an opening in the second end of the cap and into a threaded opening in the end surface of the fastening screw to secure the protective cap to the fastening screw.

### CROSS-REFERENCE

This application claims priority to German patent application no. 10 2023 205 215.6 filed on Jun. 5, 2023, the contents of which are fully incorporated herein by reference.

### TECHNOLOGICAL FIELD

The present disclosure is directed to a protective cap for a fastening screw, in particular a fastening screw in an underwater application and to an assembly of the fastening screw and the protective cap.

### BACKGROUND

In various technical fields, e.g. in offshore installations, it is necessary to anchor elements to the ground or to platforms. For this purpose, fastening screws are conventionally used, wherein for example a dynamically loaded threaded plug connection can be used. In this case, a screw is screwed into the ground or the platform, and the element to be fastened is placed on this screw. In order to connect the element to the ground or to the platform, the screw is extended, and a nut is screwed on. In the case of screw connections of this type, part of the thread protrudes and is exposed to the environmental conditions, e.g. water, wind etc. Especially in underwater applications, this means that the protruding thread is exposed to seawater, which is a corrosive and aggressive environment. The protruding threaded screw is firstly attacked on the surface and secondly contaminated, for example populated by mussels or the like. However, in order to be able to retighten the screw connection after a specific period of time, or in order to be able to release the screw connection, the surface of the screw thread needs to be clean and undamaged.

Previously, specific coatings for fastening screws were used. However, these coatings firstly cannot protect the surfaces against the growth of underwater plants/creatures, and secondly can easily be damaged during the tensioning process (e.g. either during the initial fastening or during retightening). When such a coating has been damaged, the fastening screw is no longer protected. Although the coating can be repaired, when used underwater, the repair cannot be of the same quality as the original coating. This means that the fastening element or the fastening screw has to be replaced.

Although protective caps exist for fastening screws of this type, these are not suitable for underwater use and do not offer sufficient sealing of the fastening screw with respect to the influences that are present when used underwater. Furthermore, it is not possible to ensure sufficient fastening of conventional protective caps to the fastening screw. Especially when used underwater, it is necessary to have sufficient connection between a protective cap of this type and a fastening screw, since, as a result of the challenging demands of underwater use, i.e. tides, currents, corrosive and aggressive environment, etc., the connection between the protective cap and the fastening screw is also subject to higher demands.

### SUMMARY

It is therefore an aspect of the present disclosure to provide a protective cap for a fastening screw of this type, in particular a fastening screw for underwater applications, which makes it possible to keep a protruding thread of the fastening screw clean and undamaged.

The disclosed protective cap comprises a cylindrical body having an inner and an outer lateral surface, the cylindrical body being closed at one end, and the other, open end being configured to be pushed onto the fastening screw. In this case, the inner lateral surface forms an inner receiving portion into which the fastening screw can be received. In order to now ensure a secure connection between the protective cap and the fastening screw by comparison with previous protective caps which were merely pushed onto the fastening screw, a through-hole is provided at the closed end of the protective cap, through which hole a cap screw can be guided. This screw is formed so as to engage in a corresponding hole in the fastening screw in order to connect the protective cap to the fastening screw. This means that the protective cap is firstly placed on the fastening screw, and a cap screw is subsequently screwed into the corresponding hole in the fastening screw from the outside through the through-hole. In this way, by comparison with previous protective caps, a more secure connection between the protective cap and the fastening screw is ensured.

If the fastening screw is to be released again or retightened, the protective cap can simply be removed from the fastening screw by releasing the cap screw. By means of the protective cap, the fastening screw is protected so that after removing the protective cap, an exposed thread of the fastening screw is undamaged, and therefore the fastening screw can simply be retightened, or removed/released.

So that the fastening screw can additionally be sealed, according to one embodiment, a seal can be arranged between the screw and the closed end. This means that the closed end of the protective cap is sealed by this seal. The seal is rigidly connected to the protective cap by the cap screw. In this way, it is possible to ensure that no impurities or water can enter the protective cap from outside through the through-hole for the cap screw.

According to another embodiment, an interior of the protective cap is filled with lubricant and/or corrosion protection agent. In the following, when using/mentioning a lubricant, it is also always possible to alternatively or additionally use a corrosion protection agent. Preferably, the protective cap can be filled with lubricant before being attached to the fastening screw. By means of the through-hole for guiding through the cap screw, excess lubricant can then escape when applying the protective cap to the fastening screw. In this way, the interior of the protective cap is completely filled with lubricant and can thus additionally protect the fastening screw against impurities and contact with water.

According to another embodiment, a seal is provided at the open end of the cylindrical body of the protective cap, which seal is formed so as to seal the protective cap with respect to the fastening screw. Additionally or alternatively to a seal at the closed end or the through-hole at the closed end, the open end of the cylindrical body can thus also be sealed. In this case, the seal is preferably in contact with the fastening screw, or the nut for securing the fastening screw, and thus seals the interior of the protective cap against impurities and the entry of water.

According to one embodiment, the seal is arranged on the inner lateral surface of the protective cap. Alternatively, the seal can also be provided on the edge of the open end. The seal preferably extends from the inner lateral surface beyond the edge of the open end as far as the outer lateral surface. This means that the seal can cover the open end of the protective cap. Furthermore, it is possible for the seal to be provided with at least one, preferably a plurality of sealing lips which extend radially inwards from the inner lateral surface. These sealing lips have the advantage that they can contact the fastening nut in various positions. Especially when using a plurality of sealing lips, this has the advantage that, when the outermost sealing lip is damaged, or the water pressure is too high and can overcome the outermost sealing lips, the downstream sealing lips provide additional seals. This improves the overall sealing effect of the seal or the protective cap.

The seal can comprise a plurality of sealing rings arranged axially one above the other. These sealing rings can also reach out beyond the region of the protective cap or the outer open end of the protective cap and seal the protective cap with respect to the fastening screw. The sealing rings can thus also extend the protective cap in the longitudinal extent thereof, i.e. in the axial direction of the fastening screw. In this way, the protective cap can be adapted by sealing rings of this type to various lengths of fastening screws and can reliably seal those screws. When the protective cap rests directly on the base, the protective cap, when screwed together with the fastening screw, can additionally exert axial pressure on the sealing rings and press said rings against the base. The sealing rings can thus be secured in the position thereof. Furthermore, in this manner, the sealing rings can be compressed and thus ensure the sealing effect of the sealing rings.

According to another embodiment, the protective cap is covered by the seal at least on the outer lateral surface. Preferably, the complete protective cap can also be covered by the seal, which can further improve the sealing effect of the protective cap. In particular, this can be provided in combination with a plurality of sealing rings and/or a plurality of sealing lips arranged axially one above the other.

According to another embodiment, the seal comprises a flange which extends outwards beyond the cylindrical body in the radial direction. This flange can be arranged on the ground or the base or on a fastening plate or platform through which the fastening screw extends. Thus, in addition to a seal between the fastening screw and the protective cap, a seal can also be achieved with respect to the ground or the base. This also improves the seal of the fastening screw with respect to the environment.

The protective cap preferably is formed of a plastic, in particular PBT (polybutylene terephthalate), PEEK (polyether ether ketone), PP (polypropylene) and/or PE (polyethylene). In particular, PBT offers the advantage that this is a robust, temperature-resistant and water-resistant plastics material which provides good durability especially in underwater applications of the protective cap. Alternatively, it is also possible to produce the protective cap from metal, in particular aluminum or steel.

By way of the protective cap described here, it is possible to provide good protection of a fastening screw of the type used in particular in underwater applications, such as when fastening water turbines or the like to platforms.

According to another embodiment, an assembly comprises a fastening screw having an end surface and a substantially cylindrical side surface extending axially away from the end surface and a protective cap covering the free end. The protective cap has a first end opening from which the fastening screw extends, a second end overlying the end surface of the fastening screw, a side wall surrounding a portion of the cylindrical side surface, an inner surface defining a cap interior, and an exterior surface. A cap screw extends through an opening in the second end of the cap and into a threaded opening in the end surface of the fastening screw to secure the protective cap to the fastening screw.

Further advantages and advantageous embodiments are indicated in the description, the drawings and the claims. In this case, in particular the combinations of features indicated in the description and in the drawings are given purely by way of example, and therefore the features can also be present individually or in different combinations.

### BRIEF DESCRIPTION OF THE DRAWINGS

The invention is described in greater detail in the following with reference to exemplary embodiments shown in the drawings. In this case, the exemplary embodiments and the combinations shown in the exemplary embodiments are shown purely by way of example and are not intended to establish the scope of protection of the invention. The scope is defined solely by the dependent claims.

FIG. 1 is a schematic sectional view of a protective cap on a fastening screw according to an embodiment of the present disclosure.

FIG. 2 is a schematic sectional view of the protective cap and the fastening screw from FIG. 1 in a second arrangement.

FIG. 3 is a perspective view of the protective cap of FIGS. 1 and 2.

FIG. 4 is a bottom plan view of the protective cap of FIG. 3.

FIG. 5 is a schematic sectional view of a protective cap and a fastening screw according to another embodiment.

FIG. 6 is a schematic sectional view of a detail from FIG. 5.

FIG. 7 is a schematic sectional view of the protective cap and the fastening screw of FIG. 5 in a second arrangement.

FIG. 8 is a schematic sectional view of a detail of FIG. 7.

FIG. 9 is a perspective view of an example of a seal for a protective cap.

FIG. 10 is a schematic sectional view of the seal of FIG. 9.

FIG. 11 is another embodiment of the seal from FIG. 9.

FIG. 12 is a perspective view of an installation tool for installing the sealing elements.

FIG. 13 is a perspective view of a tool for removing a protective cap according to the present disclosure.

### DETAILED DESCRIPTION

In the following, like or functionally like elements are indicated by the same reference signs.

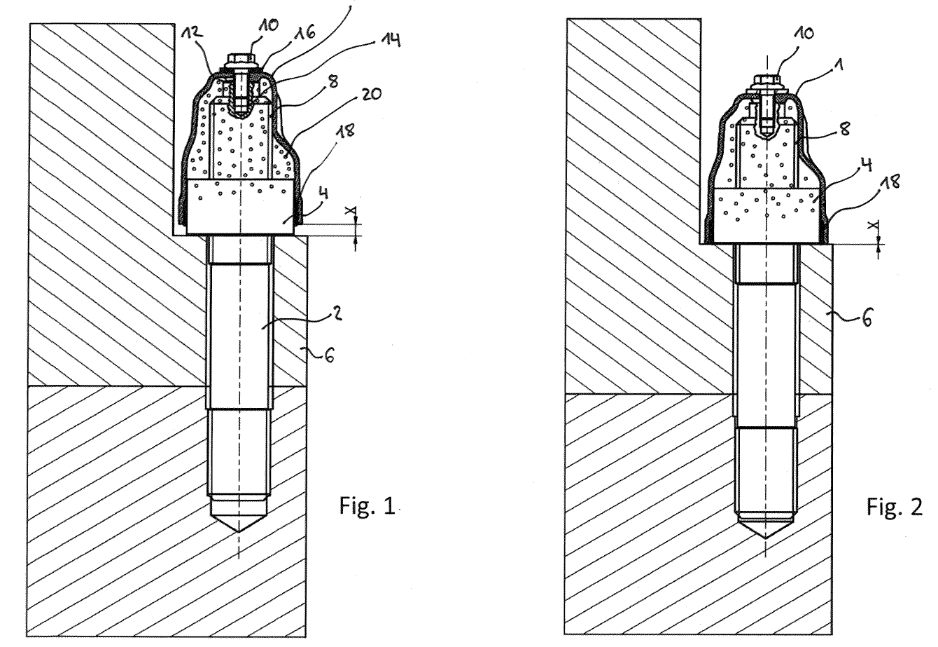

FIGS. 1 and 2 show a protective cap 1 for a fastening screw 2, wherein the fastening screw 2 in FIG. 1 protrudes to a maximum extent (by the distance X), and wherein the fastening screw in FIG. 2 protrudes to a minimal extent.

The fastening screw 2 is screwed into a base 6, for example a platform of an underwater turbine or the like. The base 6 is formed of two separate elements which are to be connected by the fastening screw 2. In this case, the fastening screw 2 is secured in the base 6 by a nut 4. This takes place in particular by extending the fastening screw 2 and subsequently screwing on the nut 4. In order to now protect the fastening screw 2, in particular the exposed thread 8, against impurities and wear, the protective cap 1 is placed on the fastening screw 2. In particular, the protective cap 1 is used to permanently protect the exposed thread 8 of the fastening screw 2 against the underwater environment in an underwater application, which environment can damage the thread 8 of the fastening screw 2 through salt water, pressure, soiling, maritime growth etc.

The protective cap 1 is secured on the fastening screw 2 by means of a cap screw 10. In this case, the cap screw 10 is inserted into a hole 14 in the fastening screw 2 through a through-opening 12 in the protective cap 1. By means of the cap screw 10, a secure connection of the protective cap 1 and the fastening screw 2 is ensured. Furthermore, this ensures simple installation and removal of the protective cap 1, since in this case, access is required only to the cap screw 10, and, if the cap screw 10 is damaged when removing the protective cap 1, the cap screw 10 can be replaced easily.

Preferably, a seal 16 is provided between the protective cap 1 and the cap screw 10 in order to seal the protective cap 1 with respect to the cap screw 10. In addition, the protective cap 1 can include a seal 18 which can be in the form of a sealing ring or a plurality of sealing rings. In this case, the seal 18 is arranged at the open end of the protective cap 1 and seals this open end with respect to the fastening screw 2 and the nut 4.

As can be seen from a comparison of FIGS. 1 and 2, in each case, the seal 18 can ensure that the protective cap 1 is sealed and thus can protect the screw 2 with respect to the environment. This is the case regardless of the distance X between the base 6 and the protective cap 1. As already mentioned above, in FIG. 1, the protective cap 1 is at a distance X from the base 6, wherein the seal 18 seals the opening of the protective cap 1. In FIG. 2, however, the protective cap 1 rests directly on the base 6, and there is no distance X. In this case, the protective cap 1 can seal directly with respect to the base 6, wherein an improved sealing effect can be ensured by the seal 18.

The protective cap 1 can additionally be filled with lubricant 20. The protective cap 1 can be filled with this lubricant 20 in advance. When applying the protective cap 1 to the fastening screw 2, excess lubricant 20, which is displaced by the fastening screw 2, can be pushed out through the opening 12 if necessary. The lubricant 20 is also used to protect the fastening screw 2 or the thread 8.

By means of the lubricant 20 which can be provided in the protective cap 1, additional protection of the fastening screw 2 against damage and corrosion, or other wear, in particular corrosion protection, can be ensured even if water or the like should enter the protective cap 1. If one of the provided seals 16, 18 fails, the pressure inside the protective cap 1 will equalize with the surrounding seawater. The incoming water can then combine with the lubricant in the protective cap 1 to form an emulsion. A water/lubricant emulsion of this type does not impair the protective environment of the protective cap 1 and thus still ensures protection against wear. Preferably, a biodegradable lubricant can be used so as not to be environmentally harmful.

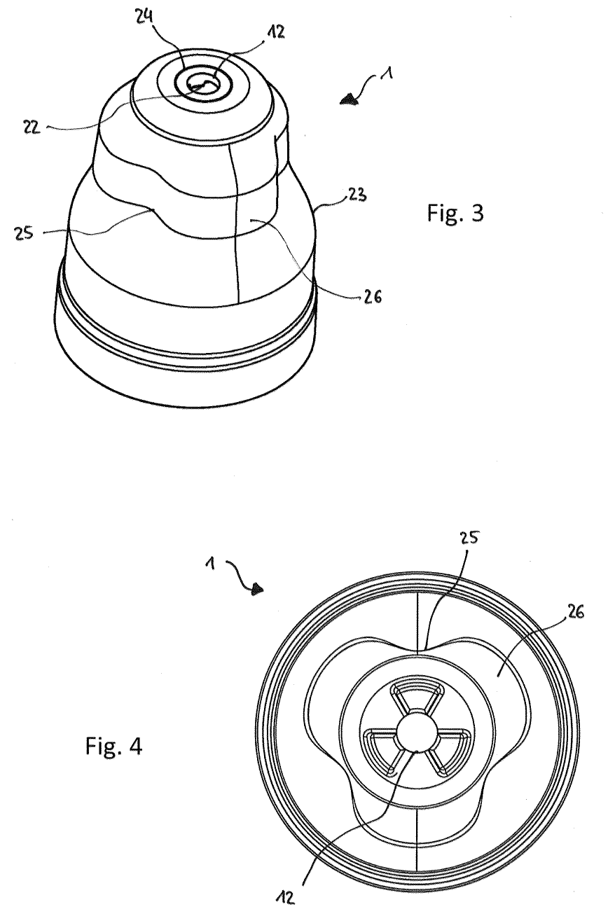

The protective cap 1 is preferably formed from PBT or a similar material since this is robust, temperature resistant and water resistant and thus suitable for an underwater application. Preferably, the protective cap 1 is formed so that the outer lateral surface 23 (FIG. 3) is smooth, thereby reducing the risk of objects such as fishing nets snagging on the protective cap 1. By connecting the protective cap 1 to the fastening screw 2 by means of the cap screw 10, a robust connection is provided, which can also withstand permanent water currents and foreign objects such as driftwood, ice and other elements.

As can be seen in FIGS. 3 and 4, a divided contact surface 22 is provided between the protective cap 1 and the fastening screw 2. The contact surface 22 is used as a primary support between the planar face of the cap screw 10 and the protective cap 1 in order to ensure a direct distribution of forces between the cap screw 10, the protective cap 1 and the fastening screw 2 in order to reduce or prevent settlement behavior firstly of the protective cap 1 and secondly of the seals as a result of stresses. This allows a rigid screw connection and, at the same time, provides paths for discharging excess lubricant 20 inside the interior of the protective cap 1 during installation.

In order to further improve the seal between the cap screw 10 and the protective cap 1, a collar 24 can be provided in addition to the seal 16. This collar 24 is used to improve the seal compression and thus the sealing capability of the seal 16. The thread interface between the thread 8 and the nut 4 can be sealed by means of a liquid sealant or a separate seal between the nut and the thread structure 8.

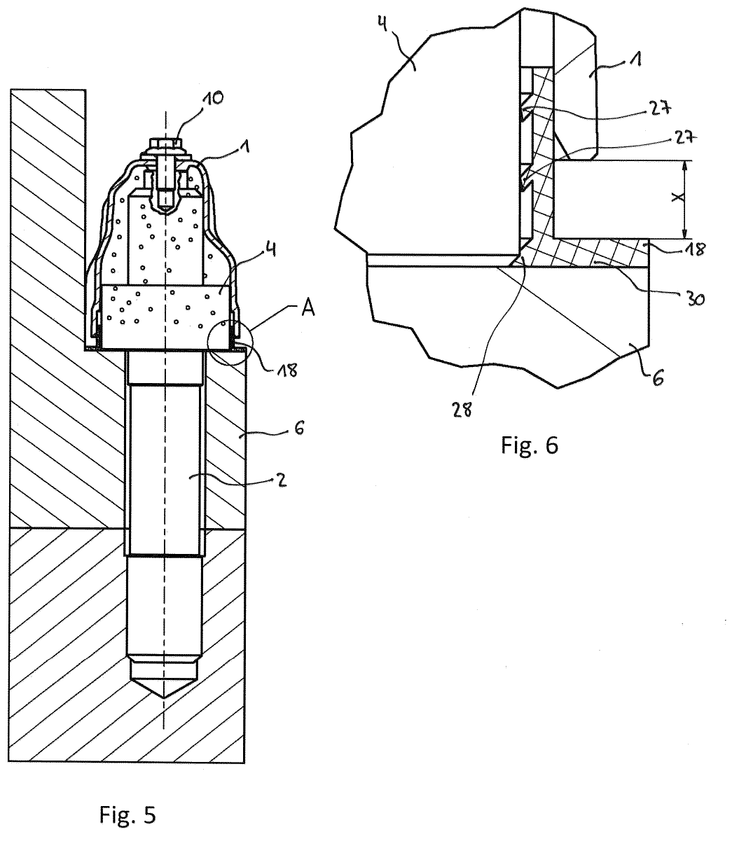

As shown in FIG. 5, the seal 18 at the open end of the protective cap 1 seals between the outer surface of the nut 4 and the protective cap 1. In this case, it is advantageous but not mandatory for the nut 4 to have a cylindrical shape. A radial design or compression of the seal 18 allows flexible tolerance in the axial direction for the thread projection X. If the thread projection X varies, as described with reference to FIGS. 1 and 2, the protective cap 1 can still be firmly applied to the fastening screw 2, and the seal 18 seals the interface between the nut 4 and the protective cap 1 in another axial position.

The outer lateral surface 23 of the protective cap 1 can include indentations 25 (FIG. 3) at least in one portion. These indentations can be used to receive the protective cap 1 and apply it to the fastening screw 2 by means of a tool or manually. In addition, the indentations 25 are used to guide the protective cap along the thread 8 of the fastening screw 2, which provides additional robustness. Between the indentations 25, bulges 26 are formed, which can be used as pockets for receiving lubricant. The indentations 25 can be in the form of axial notches or in the form of a helical rotation groove.

Preferably, the protective cap 1 can be formed without exposed connecting pieces so that internal manufacturing stresses can be kept to a minimum. In the long term, this can prevent or reduce cracks resulting from fluctuations in temperature, settlement behavior etc. This form also has the advantage that a weld seal (connection of at least two melt fronts) is avoided, which in turn could contribute to possible crack formation as a result of internal and external influences.

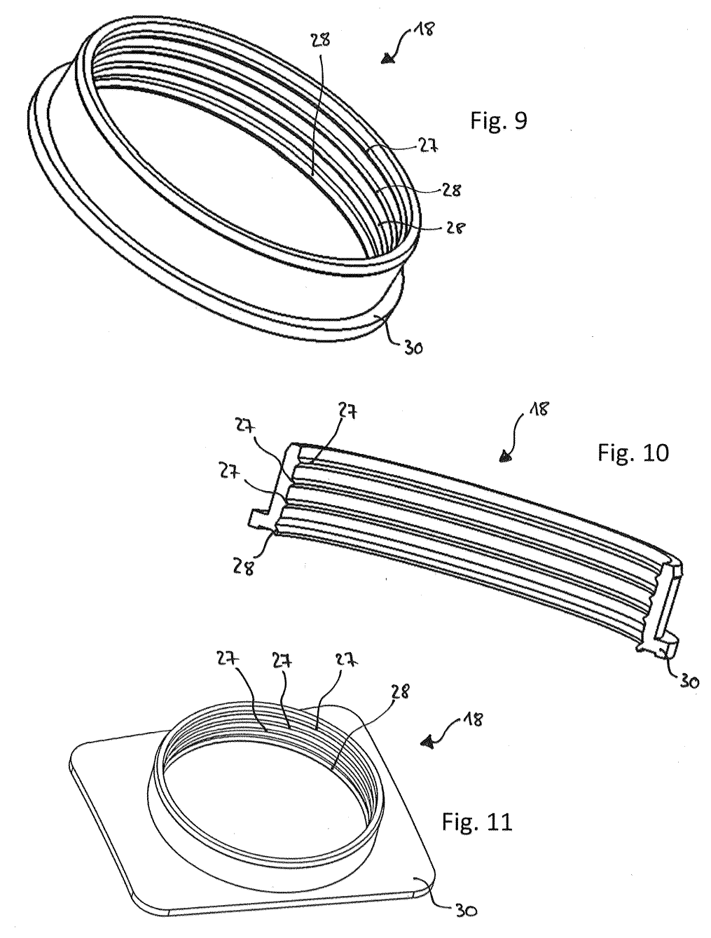

The seal 18 can have radial sealing lips 27, as shown in FIGS. 5 and 6. These sealing lips 27 provide additional sealing with respect to the nut 4. In the lower region, the seal 18 can have a slope 28 (FIGS. 9-11) to the axial seal which is firstly used for sealing with respect to the nut 4 and secondly provides a seal between the nut 4 and the base 6. In the lower region, the seal 18 can further comprise a flange 30 which allows additional sealing with respect to the base 6. By means of the flange 30, the protected region which is protected by the protective cap 1 is not limited only to the threaded portion 8 of the fastening screw 2, but also extends to the entire nut 4 and part of the base 6. In this way, it can be ensured that not only is the exposed thread 8 protected against environmental influences, but that the nut 4 also remains undamaged over time and thus can be retightened if required. In addition, a clean contact surface for the tool for tightening the fastening screw 2 is thus maintained on the base 6.

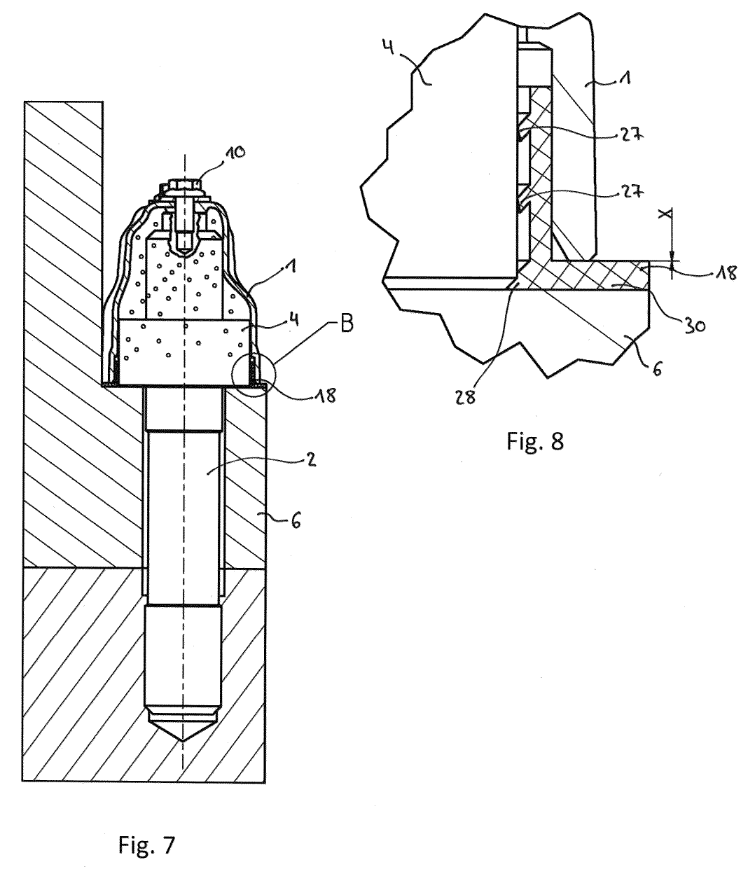

As can be seen from a comparison of FIGS. 5 and 6, and 7 and 8, the seal 18 is used both for sealing when there is a distance X between the protective cap 1 and the base 6 (FIGS. 5 and 6) and when the protective cap 1 is in direct contact with the seal 18 and thus the base 6 (FIGS. 7 and 8). By means of the seal 18, the height difference X between the protective cap 1 and the base 6 can thus be compensated for, wherein in each case, a secure seal between the protective cap 1 and the base 6 or the protective cap 1 and the nut 4 and thus the fastening screw 2 can be ensured.

The seal 18 can be formed from a plurality of O-rings that are arranged one above the other (not shown). Alternatively, the seal can be a complete sealing element, as described in detail in FIGS. 9 and 11. As can be seen in FIG. 9, the seal 18 is a cylindrical seal having a plurality of sealing lips 27 on its inner lateral surface, as has already been described previously. In this case, the upper sealing lips 27 seal the protective cap 1 with respect to the nut 4 and can either be in the form of radially obliquely extending sealing lips 27, as shown in FIGS. 5 to 8, or can be in the form of purely radially extending sealing lips 27, as can be seen in FIG. 10. In addition, the seal 18 comprises a slope 28 which is a radially obliquely extending sealing lip 28. This sealing lip 28 is used, as already described previously, for sealing between the protective cap 1, the nut 4 and the base 6. In addition, the seal 18 can comprise a flange 30, as has already been described previously. This flange 30 can either be in the form of a radial ring, as can be seen in FIGS. 9 and 10, or alternatively can comprise a greater radial extent, as shown in FIG. 11. In this case, the flange 30 can completely cover the base 6 in the region of the fastening screw 2. This provides an additional seal between the protective cap 1, the nut 4 and the base 6.

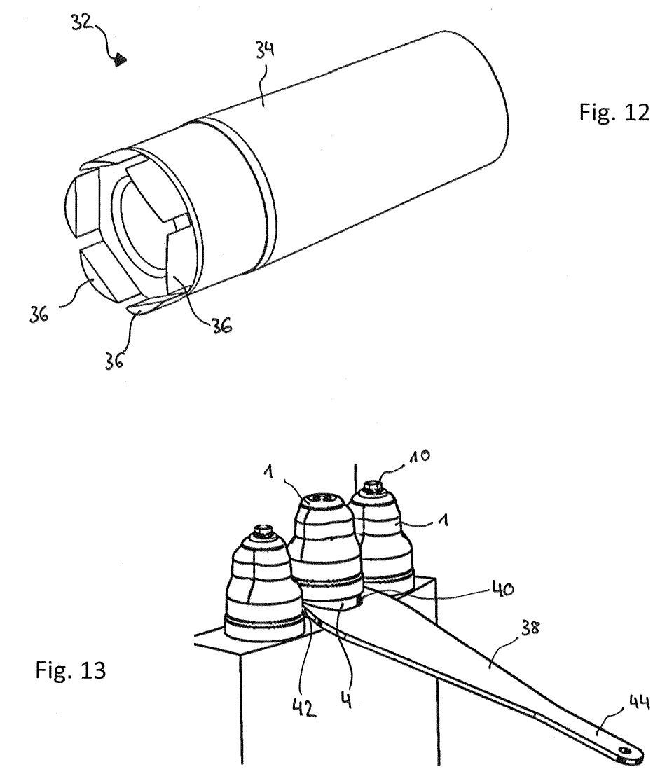

The seal 18, in particular when it is formed from a plurality of sealing rings, can be applied to the fastening screw 2 before installing the protective cap 1 by means of an installation tool 32. As shown in FIG. 12, the installation tool 32 can include a cylindrical body 34 on which the seal 18, in particular a plurality of sealing rings or also a plurality of seals 18 can be arranged. Retaining elements 36 can be formed on one end of the installation tool 32. In this case, the retaining elements 36 are configured in such a way that they can receive the fastening screw 2 and the nut 4 therebetween. In order to install the seal 18, the installation tool 32 is placed on the nut 4. By means of the installation tool 32, the seal 18 can then be moved along the cylindrical or conical body 34 as far as the nut 4 and moved down off the installation tool 32. When the seal 18 is no longer located on the installation tool 32, but rather is arranged around the nut 4, the installation tool 32 can be removed, and the protective cap 1 can subsequently be placed on the fastening screw 2.

In order to remove the protective cap 1, a removal tool 38 can be used, as shown in FIG. 13. The removal tool 38 comprises a recess 40 which can engage around the nut 4 in the manner of a wrench. In the region of the recess 40, the removal tool 38 can comprise a taper so that it can easily be inserted under the protective cap 1, or between the protective cap 1 and the base 6. In order to remove the protective cap 1, the removal tool 38 is guided between the protective cap 1 and the base 6 so that the recess 40 engages around the nut 4. By means of a handle 44, the protective cap 1 can be levered upwards and away from the base 6 and thus removed in the form of a lever movement. Prior to this, the cap screw 10 is loosened in order to disconnect the screw connection between the protective cap 1 and the fastening screw 2.

By means of the protective cap 1 described here, more secure and durable protection of a fastening screw can be ensured, of the type used for example in an underwater application. In particular, corrosion or other contamination of an exposed thread of the fastening screw can be prevented.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved protective caps for screws.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

### LIST OF REFERENCE SIGNS

1 protective cap
2 fastening screw
4 nut
6 base
8 exposed thread
10 screw
12 through-hole
14 hole
16 seal
18 seal
20 lubricant
22 contact surface
23 outer lateral surface
24 collar
25 indentations
26 bulges
27 sealing lips
28 slope
30 flange
32 installation tool
34 cylindrical body
36 retaining elements
38 removal tool
40 recess
42 taper
44 handle
X distance

What is claimed is:

1. An assembly comprising:
a fastening screw having an end surface and a substantially cylindrical side surface extending axially away from the end surface,
a protective cap covering the free end and having a first end opening from which the fastening screw extends, a second end overlying the end surface of the fastening screw, a side wall surrounding a portion of the cylindrical side surface, an inner surface defining a cap interior, and an outer surface,
a cap screw extending through an opening in the second end of the cap and into a threaded opening in the end surface of the fastening screw to secure the protective cap to the fastening screw.

2. The assembly according to claim 1,
wherein the cap interior is filled with a lubricant and/or a corrosion protection agent.

3. The assembly according to claim 2,
including a first seal member between a head of the cap screw and the outer surface of the second end of the protective cap.

4. The assembly according to claim 3,
wherein at least one second seal member is mounted in the cap interior between the fastening screw and the inner surface of the cap at the first end opening to seal the cap interior.

5. The assembly according to claim 4,
wherein a portion of the at least one second seal member is located axially outside the cap interior.

6. The assembly according to claim 5,
wherein the portion of the at least one second seal member extends radially outward from the outer surface of the protective cap.

7. The assembly according to claim 3,
wherein the at least one second seal member includes at least one sealing lip extending radially inward toward the side surface of the fastening screw.

8. The assembly according to claim 7,
wherein the at least one sealing lip comprises a plurality of sealing lips.

9. The assembly according to claim 4,
wherein the at least one second seal member comprises a plurality of sealing rings arranged axially one above the other.

10. The assembly according to claim 4,
wherein the at least one second seal member covers an axial end of the protective cap.

11. The assembly according to claim 4,
wherein the at least one second seal member includes a flange extending radially outwardly from the outer surface of the protective cap.

12. The assembly according to claim 1,
including:
a first seal member between a head of the cap screw and an outer surface of the second end of the protective, and
at least one second seal member mounted in the cap interior between the fastening screw and the inner surface of the cap at the first end opening to seal the cap interior,
wherein the cap interior is filled with a lubricant and/or a corrosion protection agent,
wherein a portion of the at least one second seal member is located axially outside the cap interior and extends radially outward from an outer surface of the protective cap, and
wherein the at least one second seal member includes at least one sealing lip extending radially inward toward the side surface of the fastening screw.

13. The assembly according to claim 1,
including a first seal member between a head of the cap screw and an outer surface of the second end of the protective cap.

14. The assembly according to claim 13,
wherein at least one second seal member is mounted in the cap interior between the fastening screw and the inner surface of the cap at the first end opening to seal the cap interior.

15. The assembly according to claim 14,
wherein a portion of the at least one second seal member is located axially outside the cap interior.

16. The assembly according to claim 15,
wherein the portion of the at least one second seal member extends radially outward from an outer surface of the protective cap.

17. The assembly according to claim 14,
wherein the at least one second seal member includes at least one sealing lip extending radially inward toward the side surface of the fastening screw.
